(19) United States
(12) Patent Application Publication
(10) Pub. No.: US 2018/0201356 A1
(43) Pub. Date: Jul. 19, 2018

(54) ELLIPSOIDAL AIRCRAFT

(71) Applicant: Bo CAI, Shantou City (CN)

(72) Inventor: Bo CAI, Shantou City (CN)

(21) Appl. No.: 15/686,714

(22) Filed: Aug. 25, 2017

(30) Foreign Application Priority Data
Jan. 16, 2017 (CN) 201720047584.7

(51) Int. Cl. B64C 1/00; B64C 39/02

(52) U.S. Cl. CPC B64C 1/00; B64C 39/024; B64C 25/06; B64C 2201/108; B64C 2001/0045

(57) ABSTRACT

The utility model provides an ellipsoidal aircraft, wherein the housing is provided with an upper cover and a pedestal, the pedestal is coaxial with the housing, a whirling arm is arranged at a junction between the upper cover and the housing, and a fixing sleeve internally equipped with a motor is arranged at a middle position of a lower side of the whirling arm. Such design effectively prevents blades and the motor from being damaged due to loosening of the whirling arm during transmission and solves the problem that conventional equipment is easily damaged.

### FIELD OF THE UTILITY MODEL

The utility model belongs to the field of aircraft equipment and relates to an ellipsoidal aircraft.

### BACKGROUND OF THE UTILITY MODEL

In the prior art, unmanned aerial vehicles (UAVs) can be divided into military and commercial UAVs according to application fields. In the military aspect, UAVs are divided into scoutplanes and target drones. In the commercial aspect, the application of UAVs to industries is the real rigid demand of UAVs; and the current application of UAVs to fields such as aerial photography, agriculture, plant protection, self-timer shooting, express delivery, disaster rescue, wildlife observation, infectious disease monitoring, mapping, news reporting, power patrol inspection, disaster relief, film and television shooting and romance making greatly expands the use of UAVs per se, and the expansion of industry application and the development of UAV technologies are also actively carried out in developed countries, but for children, UAVs have the problems of being easily damaged and inconvenient to operate, so there is a need for new equipment to solve the above problems.

### SUMMARY OF THE UTILITY MODEL

For the disadvantages of the prior art, an object of the utility model is to provide an ellipsoidal aircraft so as to solve the problems mentioned in the above background section. The ellipsoidal aircraft of the utility model is convenient to use and operate, and has high stability and high reliability.

To achieve the above object, the utility model is realized by the following technical solution: an ellipsoidal aircraft comprises an upper cover, a whirling arm, a clamping buckle, blades, a motor, a pedestal, a clamping slot, a housing and a fixing sleeve, wherein the upper cover is mounted at an upper end of the housing, the pedestal is assembled at a lower end of the housing, the pedestal is of a disc-shaped structure, a central axis of the pedestal and a central axis of the housing are on the same straight line, the whirling arm is mounted at a junction between the upper cover and the housing by a rotating shaft, the fixing sleeve is assembled at a middle position of a lower side of the whirling arm, the fixing sleeve is of a cylindrical structure, the fixing sleeve is internally equipped with the motor, the motor is of a cylindrical structure in outer shape, a central axis of the motor and a central axis of the fixing sleeve are on the same straight line, the motor and the blades are assembled together, the clamping buckle is mounted at a tail end of the whirling arm, a groove is arranged on a spherical side face of the housing, the clamping slot is arranged at a lower end of the groove, and the clamping buckle is engaged with the clamping slot.

Further, four grooves having the same specification are distributed on the spherical side face of the housing, and the four grooves are disposed at an included angle of 90° to the central axis of the housing.

Further, the pedestal distributed at the lower end of the housing is made of a rubber material.

Further, four said whirling arms are arranged, and the four whirling arms are disposed at an included angle of 90° to the central axis of the housing.

Further, a switch button is fixed at the lower end of the housing.

The utility model has the following beneficial effects: the utility model provides an ellipsoidal aircraft, wherein the pedestal is added to stably control the takeoff and landing process of the ellipsoidal aircraft of the utility model and increase the contact area between the housing and the ground to prevent rollover; in addition, the pedestal made of a rubber material can effectively absorb the kinetic energy during landing, thus preventing electronic components in the housing from being damaged due to hard contact; in addition, a foldable design in the utility model facilitates protecting the motor and the blades, thus solving the problem that blades and a motor of conventional equipment are easily damaged; and the whirling arm is engaged with the clamping slot located in the groove of the housing by the clamping buckle, the design of which can effectively prevent the blades and the motor from being damaged due to loosening of the whirling arm during transmission, and solves the problem that conventional equipment is easily damaged. The ellipsoidal aircraft of the utility model is convenient to use and operate, and has high stability and high reliability.

### BRIEF DESCRIPTION OF THE DRAWINGS

Other features, objects and advantages of the utility model will become more apparent by reading the detailed description of non-limiting embodiments made with reference to the following accompanying drawings.

FIG. 1 is a schematic structural view of an ellipsoidal aircraft of the utility model; and

FIG. 2 is a front schematic structural view of an ellipsoidal aircraft of the utility model.

In the Figures: 1—upper cover; 2—whirling arm; 3—clamping buckle; 4—blade; 5—motor; 6—pedestal; 7—clamping slot; 8—housing; 9—fixing sleeve.

### DETAILED DESCRIPTION OF THE UTILITY MODEL

In order that the technical means, inventive features, objects and efficacies of the utility model are readily understood, the utility model will be further described below in conjunction with particular embodiments.

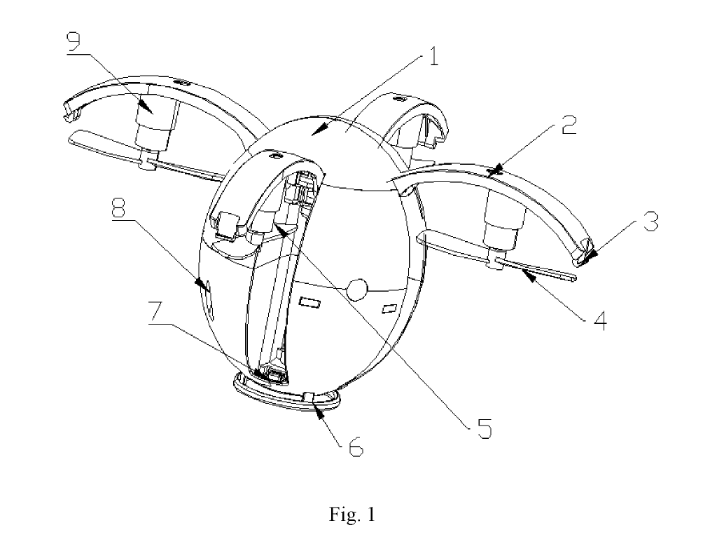

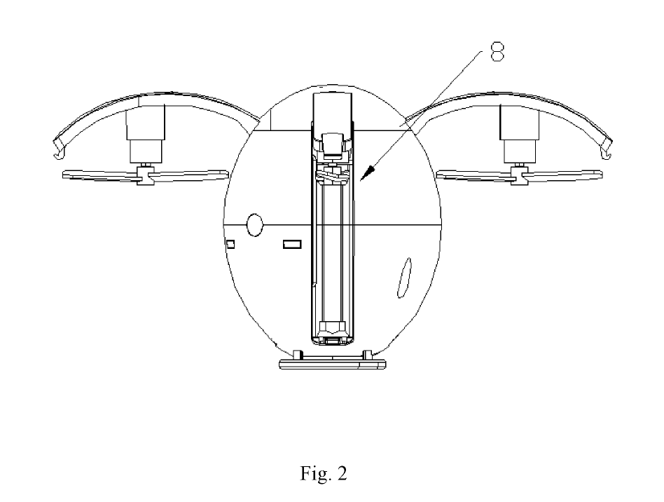

Referring to FIGS. 1 and 2, the utility model provides a technical solution: an ellipsoidal aircraft comprises an upper cover 1, a whirling arm 2, a clamping buckle 3, blades 4, a motor 5, a pedestal 6, a clamping slot 7, a housing 8 and a fixing sleeve 9, wherein the upper cover 1 is mounted at an upper end of the housing 8; the pedestal 6 is assembled at a lower end of the housing 8; the pedestal 6 is of a disc-shaped structure; a central axis of the pedestal 6 and a central axis of the housing 8 are on the same straight line; the pedestal 6 is added to stably control the takeoff and landing process of the ellipsoidal aircraft of the utility model and increase the contact area between the housing and the ground to prevent rollover; in addition, the pedestal 6 made of a rubber material can effectively absorb the kinetic energy during landing, thus preventing electronic components in the housing 8 from being damaged due to hard contact; the whirling arm 2 is mounted at a junction between the upper cover 1 and the housing 8 by a rotating shaft; the fixing sleeve 9 is assembled at a middle position of a lower side of the whirling atm 2; the fixing sleeve 9 is of a cylindrical structure; the fixing sleeve 9 is internally equipped with the motor 5; the motor 5 is of a cylindrical structure in outer shape; a central axis of the motor 5 and a central axis of the fixing sleeve 9 are on the same straight line; the motor 5 and the blades 4 are assembled together; the clamping buckle 3 is mounted at a tail end of the whirling arm 2; a groove is arranged on a spherical side face of the housing 8; the clamping slot 7 is arranged at a lower end of the groove; and the clamping buckle 3 is engaged with the clamping slot 7.

Four grooves having the same specification are distributed on the spherical side face of the housing 8, and the four grooves are disposed at an included angle of 90° to the central axis of the housing 8. The pedestal 6 distributed at the lower end of the housing 8 is made of a rubber material. A foldable design in the utility model facilitates protecting the motor 5 and the blades 4, thus solving the problem that blades 4 and a motor 5 of conventional equipment are easily damaged. Moreover, the whirling arm 2 is engaged with the clamping slot 7 located in the groove of the housing 8 by the clamping buckle 3, the design of which can effectively prevent the blades 4 and the motor 5 from being damaged due to loosening of the whirling arm 2 during transmission, and solves the problem that conventional equipment is easily damaged. Four whirling arms 2 are arranged, and the four whirling arms 2 are disposed at an included angle of 90° to the central axis of the housing 8. A switch button is fixed at the lower end of the housing 8.

The utility model is specifically implemented as follows: when in use, an operator first checks whether the ellipsoidal aircraft of the utility model has defects, if yes, the aircraft cannot be used and then a repairman is notified, if not, the aircraft can be used; before use, a user first places the ellipsoidal aircraft of the utility model on the ground, then loosens the connection position of the clamping slot 7 and the clamping buckle 3, then rotates the whirling atm 2 and adjusts the position of the whirling arm 2 such that the central axis of the motor 5 and the horizontal plane are at an included angle of 90°; the aircraft can be used after fixing, and then remote control equipment can be used to control the rotation of the motor 5, thus controlling the takeoff and landing of the ellipsoidal aircraft of the utility model; when the aircraft needs to land, the pedestal 6 contacts the ground, then the pedestal 6 made of a rubber material can effectively function to buffer, and the kinetic energy produced by rubber absorption further facilitates the stable landing of the ellipsoidal aircraft of the utility model; and when the aircraft needs to be retracted, the user rotates the position of the blades 4 such that the blades 4 are disposed in parallel to the groove, and then the clamping buckle 3 on the whirling arm 2 is engaged with the clamping slot 7 in the groove, thus achieving the purpose of protection.

The basic principles, main features and advantages of the utility model have been illustrated and described above, but for those skilled in the art, the utility model is apparently not limited to the details of the above exemplary embodiments, and the utility model can be implemented in other specific forms without departing from the spirit or basic features of the utility model. Accordingly, anyway, the embodiments should be considered to be exemplary and non-limiting. The scope of the utility model is defined by the appended claims rather than the above description, thus all changes falling within the meaning and scope of equivalent conditions of the claims are intended to be included in the utility model. Any reference numeral in the claims should not be regarded as limiting the claims involved.

In addition, it should be understood that the present description is described in accordance with embodiments, but not every embodiment only contains one independent technical solution, and such narrative manner of the present description is only for the sake of clarity, thus those skilled in the art should regard the present description as a whole, and the technical solutions in various embodiments may also be appropriately combined to form other embodiments that may be understood by those skilled in the art.

1. An ellipsoidal aircraft, comprising an upper cover, a whirling arm, a clamping buckle, blades, a motor, a pedestal, a clamping slot, a housing and a fixing sleeve, wherein the upper cover is mounted at an upper end of the housing, the pedestal is assembled at a lower end of the housing, the pedestal is of a disc-shaped structure, a central axis of the pedestal and a central axis of the housing are on the same straight line, the whirling arm is mounted at a junction between the upper cover and the housing by a rotating shaft, the fixing sleeve is assembled at a middle position of a lower side of the whirling arm, the fixing sleeve is of a cylindrical structure, the fixing sleeve is internally equipped with the motor, the motor is of a cylindrical structure in outer shape, a central axis of the motor and a central axis of the fixing sleeve are on the same straight line, the motor and the blades are assembled together, the clamping buckle is mounted at a tail end of the whirling arm, a groove is arranged on a spherical side face of the housing, the clamping slot is arranged at a lower end of the groove, and the clamping buckle is engaged with the clamping slot.

2. The ellipsoidal aircraft according to claim 1, wherein four grooves having the same specification are distributed on the spherical side face of the housing, and the four grooves are disposed at an included angle of 90° to the central axis of the housing.

3. The ellipsoidal aircraft according to claim 1, wherein the pedestal distributed at the lower end of the housing is made of a rubber material.

4. The ellipsoidal aircraft according to claim 1, wherein four said whirling anus are arranged, and the four whirling arms are disposed at an included angle of 90° to the central axis of the housing.

5. The ellipsoidal aircraft according to claim 1, wherein a switch button is fixed at the lower end of the housing.
